(19) United States
(12) Patent Application Publication
(10) Pub. No.: US 2011/0221615 A1
(43) Pub. Date: Sep. 15, 2011

(54) System and Method for Informing Public Transport Vehicle Arrival Information

(76) Inventor: Sandy Sanderson Chiu, Wanchai (HK)

(21) Appl. No.: 13/130,575

(22) PCT Filed: Nov. 23, 2009
(86) PCT No.: PCT/CN09/75073

§ 371 Date: May 22, 2011

(30) Foreign Application Priority Data
Nov. 25, 2008 (HK) 08112880.0

(51) Int. Cl. G08G 1/123

(52) U.S. Cl. 340/988

(57) ABSTRACT

A system for informing public transport vehicle arrival information includes a plurality of on-board devices installed on respective public transport vehicles, each of the on-board device having a transceiver for transmitting and receiving data from and to public transport vehicle stops along a public transport vehicle line, a first processing unit programmed to store and process the received data, and a first display module which is operatively coupled to the first processing unit and is for displaying the data and a plurality of public transport vehicle stop devices installed in the respective vehicle stops, each of the public transport vehicle stop device having a preset vehicle identification therein and having a transceiver for transmitting and receiving the data from and to the on-board device.

### CROSS REFERENCE TO RELATED APPLICATIONS

This utility patent application is a national phase entry under 35 USC §371 of international application number PCT/CN2009/075073 filed on Nov. 23, 2009, and claims priority to Hong Kong application number 08112880.0 filed on Nov. 25, 2008, which are incorporated by reference herein.

### FIELD OF THE INVENTION

This invention relates generally to a system for informing public transport vehicle arrival information, and more particularly, to a system informing a public transport vehicle waiting time based on available schedule time frame of the public transport vehicle.

### BACKGROUND OF THE INVENTION

People spend a lot of their time on waiting for public transport vehicles to their destination at vehicle stops because of the uncertainty about vehicle arrival times. It is desirable to provide passengers waiting at public transport vehicle stops with more information. For example, what the passengers want to know most is when the next upcoming vehicle will arrive. To solve this problem, numerous prior art methods and systems are proposed for displaying the arrival times of a public transport vehicle.

Global Positioning system (GPS) tracking system is a type of system which can tell the passengers the arrival time of the next bus. However, GPS system is too expensive to be built, installed & maintained at each single bus and bus stop.

JP2002-109688 discloses a bus operation display system, in which operation schedule information is stored in each of a plurality of bus stops, the arrival and passing of a bus to the bus stop are detected by performing the send and receive of information only between the bus stop and the bus, and the operation schedule information reflect the operation state which is determined, on the basis of the detection result and the operation schedule information is displayed in the display part of the bus stop. However, this system consists of the following drawbacks:—
all bus schedule information needs to be preset to each bus stop device before operation;
when a new schedule is to be updated, time and labor intensive is required to update each bus stop preset schedules; and
there is no flexibility because this system would not work if the bus schedule changes in real time.

FR264602A1 relates to an information device for users waiting at a public transport vehicle stop. This device comprises a transmitter on each vehicle and a receiver on at least some of the stops, and the receivers control a display device. However, the device of FR264602A1 can only display the last passing bus time, the users need to check the bus schedule panel and subtract the last bus passing time if they want to know the expected waiting time. In addition, this device would not work if the bus schedule changes and not updated to the schedule panel attached on the bus stop.

Based upon the foregoing, it should be noted that all of these methods and systems only work on preset array, predefined bus timetable which is stored in each bus stop electronically. But the passengers waiting at the bus stops cannot know the actual departure frequency of the bus or whether there are bus schedule cancellations. Moreover, these methods and systems in existence are inflexible for random deployment at bus stops and not easily adaptive to cater for the change of bus routes and traffic conditions.

Therefore, it would be desirable to have a system and a method that would allow to inform the passengers public transport vehicle arrival times and that are relatively flexible and less-affected by traffic conditions and environment. It would also be desirable to provide public transport vehicle information which is simple and cost-effective.

### SUMMARY OF THE INVENTION

The present invention has been developed to fulfill the needs noted above and therefore has a principle object of the provision of a system which can permit passengers to know the waiting time of public transport vehicle regardless of traffic conditions and environments.

Another object of the invention is to provide a system for informing public transport vehicle arrival information which is significantly more economical and convenient to install at the stops along a public transport vehicle line than those in the prior art.

A yet further object of the invention is to provide a system for informing public transport vehicle arrival information which is able to add, cancel or adjust bus service modes and schedule time at any time due to specific events such as weather, traffic accidents and/or road construction.

These and other objects and advantages of the invention are satisfied by providing a system for informing public transport vehicle arrival information, comprising:

a plurality of on-board devices installed on respective public transport vehicles, each of the on-board device having a transceiver for transmitting and receiving data from and to public transport vehicle stops along a public transport vehicle line, a first processing unit programmed to store and process the received data, and a first display module which is operatively coupled to the first processing unit and is for displaying the data, wherein the data includes identification of the vehicle, schedule time frame and next schedule departure time of a following vehicle, the schedule time frame being obtained by subtracting a current departure time at a vehicle terminus from a next schedule departure time; and

a plurality of public transport vehicle stop devices installed in the respective vehicle stops, each of the public transport vehicle stop device having a preset vehicle identification therein and having a transceiver for transmitting and receiving the data from and to the on-board device if the preset vehicle identification matches the vehicle identification of the on-board device, a second processing unit programmed to store and update the received data to count down a waiting time of the vehicle till zero and then, if necessary, switch to count up a delay time, and a second display module which is operatively coupled to the second processing unit and is for displaying the waiting time or the delay time and other information.

In one preferred embodiment of the invention, the transceivers installed on the public transport vehicles and the public transport vehicle stops are short distance transceivers, and selected from the group consisting of infrared transceiver, radio frequency transceiver and Bluetooth transceiver.

Preferably, the first processing unit and the second processing unit are integrated circuit (IC) or microprocessor.

Preferably, the vehicle identification is route code; and the arrival information includes mode codes of the vehicle.

In another preferred embodiment of the invention, a further transceiver is installed on the other side of the vehicle as a relaying transceiver to better perform the transmission of the data between the vehicles and the stops.

The second processing unit may be programmed to transmit confirmation of receipt of the data to the on-board device in order to let the driver of the vehicle know that the data has been successfully received by the public transport vehicle stop devices.

In the system of the invention, a digital display or a LCD display may be selected as the second display.

According to the invention, the arrival information may be displayed in various formats. For example, the arrival information can be display in the format of the count down time frame or in the format of next schedule arrival time which is obtained by adding the schedule time frame to the current clock time of each of the vehicle stops.

For information or advertising purposes, promotional messages, product information, news and weather briefs or the like may be stored in the second processing unit so that they are made available intermittently to the public at the vehicle stops.

The invention further relates to a method for informing public transport vehicle arrival information, comprising the steps of:

a) providing a plurality of on-board devices installed on respective public transport vehicles;

b) providing a plurality of public transport vehicle stop devices with preset identification of the vehicle, which are installed in the respective vehicle stops along a public transport vehicle line;

c) inputting identification of the vehicle, mode code and schedule time frame or next schedule departure time of a following vehicle into the on-board devices, the schedule time frame being obtained by subtracting a current departure time at a vehicle terminus from a next schedule departure time;

d) transmitting the vehicle identification, mode code and the schedule time frame to the plurality of public transport vehicle stop devices wherein the mode code and/or the schedule time frame is received and updated if the preset identification of the vehicle matches the vehicle identification of the on-board device;

e) on the basis of the updated schedule time frame, counting down a waiting time of the vehicle till zero and then, if necessary, switching to count up a delay time; and

f) displaying the waiting time or the delay time.

In one preferred embodiment, the method of the invention further comprises the step of transmitting confirmation of receipt of the vehicle identification, the mode code and/or the schedule time frame from the public transport vehicle stop device to the on-board device.

Advantageously, the step c) comprises displaying the vehicle identification and the schedule time frame or next schedule departure time of a following vehicle.

In step f), the waiting time may be displayed in the format of the countdown time frame or in the format of next schedule arrival time, the next schedule arrival time being obtained by adding the schedule time frame to the current clock time of each of the vehicle stops. The step f) further comprises displaying promotional messages, product information, news and weather briefs or the like.

In contrast to the systems for displaying the arrival times available in the prior art, the system of the invention utilizes the schedule time frame, which is obtained by subtracting a current departure time at a vehicle terminus from a next schedule departure time, as the basis for counting down the waiting time at the stops, and thus eliminating the need of presenting bus schedule panel and of predefining schedule, and the need of using computers and network arrangements. The system of the invention is able to operate on live events and last moment schedule planning, and would not be affected by the traffic conditions and environment.

To have a better understanding of the invention reference is made to the following detailed description of the invention and embodiments thereof in conjunction with the accompanying drawings.

### BRIEF DESCRIPTION OF THE DRAWINGS

FIG. 1 is a diagram schematically illustrating structure of an on-board device utilized in a system according to the invention.

FIG. 2 is a diagram schematically illustrating structure of a stop device utilized in a system according to the invention.

FIG. 3 is a block diagram schematically illustrating the workflow of the system for informing public transport vehicle arrival information constructed in accordance with one preferred embodiment of the invention.

FIGS. 4A to 4F are schematic diagrams showing how the system of FIG. 3 works.

In the various figures of the drawings, like reference numbers are used to designate like parts.

### DETAILED DESCRIPTION

While this invention is illustrated and described in preferred embodiments, the system of the invention may be produced in many different configurations, sizes, and forms.

For the sake of clarity and convenience, “bus” is taken herein as one example of the public transport vehicles. It would be appreciated that any other public transport vehicles are applicable.

According to a preferred embodiment of the invention, a system for informing bus arrival time comprises a plurality of on-board devices 100 which are installed on the respective buses, and a plurality of bus stop devices 200 which are installed in the respective bus stops along a bus line.

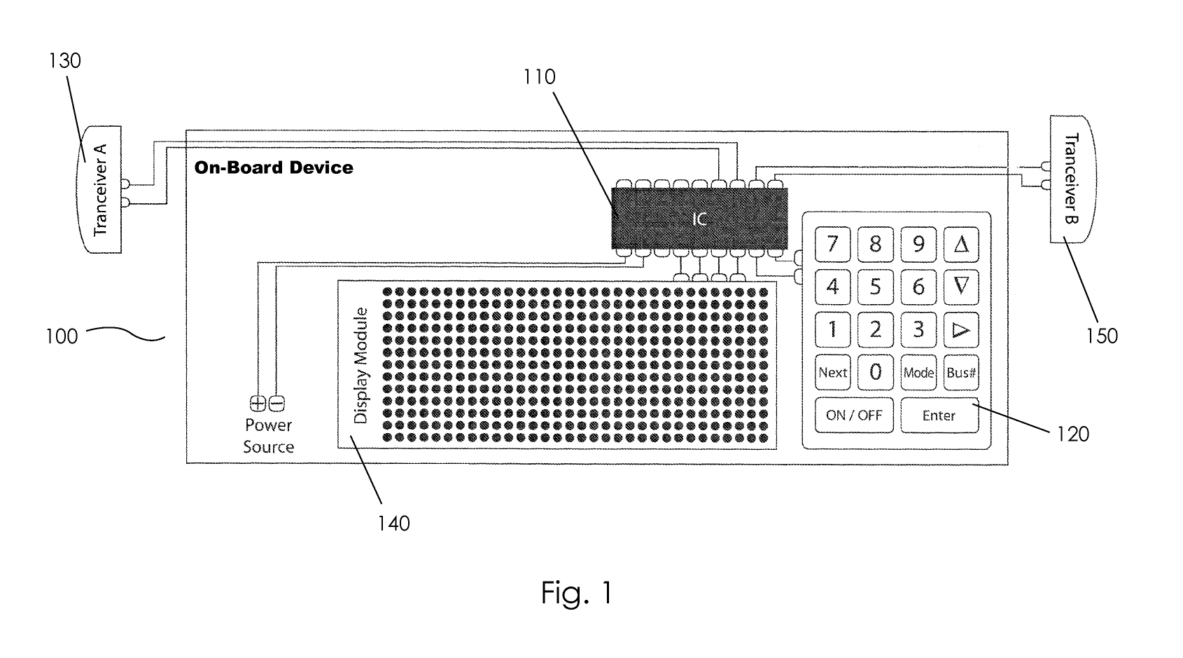

Referring now to FIG. 1, the on-board device 100 comprises a first processor unit; a keypad 120 connected to the first processor unit; a first transceiver 130 connected to the first processor unit and disposed on the front of the bus; and a first display module 140 operatively connected to the first processor unit. The first processor unit can be an IC or a microprocessor, and the IC 110 is used in this embodiment. The IC 110 is powered by the bus power supply, and programmed to store and process data including unique bus identification such as bus route code, vehicle license number or other codes to distinguish the bus vehicle, mode code, schedule time frame and next schedule departure time of the bus of the same identification. The keypad 120 is provided for inputting the data into the IC 110. According to the invention, the first transceiver 130 is a short distance transceiver, for example, infrared transceiver, radio frequency transceiver or Bluetooth transceiver. In this embodiment, the transceiver 130 is an infrared transceiver for transmitting the stored bus route code, mode code and schedule time frame of the next bus to the bus stop devices 200 and receiving data from the bus stop devices 200. The first display module 140 is caused by the IC 110 to display the time data. Generally, the on-board device 100 is arranged near to the driver of the bus for convenience.

The on-board device 100 always keeps transmitting out the data all the time after the data is input into this device. There is no need to press any other buttons or do calculation for obtaining the bus arrival information, and the data can be received by the bus stop device 200 if the on-board device and the bus stop device are within the transmitting range.

In the case that several buses of different route codes arrive simultaneously at the same bus stop, the short distance transceiver at the outmost may not work satisfactorily with the bus stop device. To resolve this problem, a further transceiver 150, which functions as a relay for transmitting and receiving the data between the outmost bus and the bus stop device, may be arranged on the bus, as shown in FIG. 1.

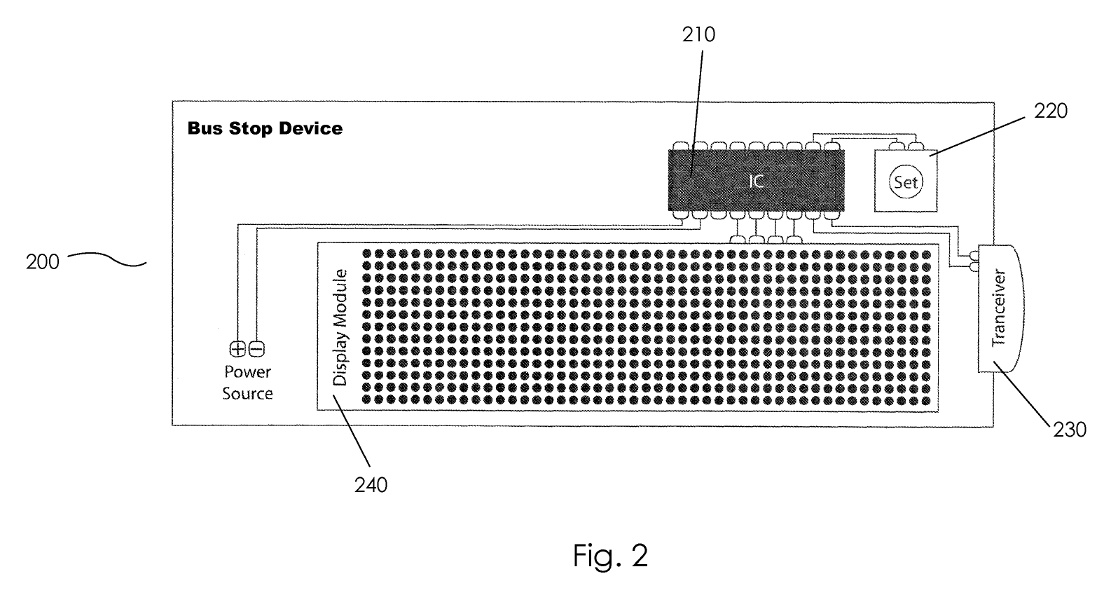

FIG. 2 shows a bus stop device of the system of the invention. This bus stop device 200 comprises a second processor unit; a preset means 220 connected to the second processor unit; a second transceiver 230 connected to the second processor; and a second display module 240 operatively connected to the first processor unit. Generally, the bus stop device is preset with a bus identification such as bus route code, vehicle license number or other codes in order to match with the identification of the on-board device. The second transceiver 230 is also a short distance transceiver selected from, for example, infrared transceiver, radio frequency transceiver or Bluetooth transceiver. Like the first processor unit, the second processor unit can be an IC or a microprocessor, and the IC 210 is used as the second processor unit in this embodiment. The IC 210 may be powered by the power cables available at the bus stop, and preferably by solar panel with rechargeable batteries which allow to self-maintain the power source without power failure. The IC 210 is programmed to store and process the data. In particular, the IC 210 is programmed to update the data including the schedule time frame which is received by the second transceiver 230 from the on-board device 100 when the bus having the identification matchable with the preset one of the bus stop device passes by the bus stop. Then, the IC 210 starts to count down a waiting time of the bus once the schedule time frame is received from the pass-by bus. If the upcoming bus does not arrive at the bus stop till the waiting time is counted down to zero, the IC 210 would then switch to count up a delay time until the arrival of this bus. The second display module 240 is also caused by the IC 210 to display the waiting time or the delay time. A digital display or a LCD display can be used as the second display module 24. In the case of the LCD display, promotional messages, product information or the like may be displayed on the second display module 240 for advertising purpose. Alternatively, news and weather briefs may be made available to the passengers through the second display module 240. These additional information can stored in the second processor unit.

According to the context of the invention, the term “schedule time frame” is defined as a time frame obtained by subtracting a current departure time at a bus terminus from a next schedule departure time, such as 10 minutes, 15 minutes, 30 minutes, etc. . . . In other words, this time frame represents the waiting time of the next bus and can be displayed and counted down on the second display module 240 to inform the passengers how long the next bus will arrive. As a variation, the second display module 240 can display the waiting time in the format of next schedule arrival time which is obtained by adding the schedule time frame to the current clock time of each of the bus stops.

The second display module 240 at each of the bus stops can also display mode codes of the bus to reflect different bus service conditions. For example, the mode codes include the following:
“next bus” represents the upcoming bus will be arriving;
“delayed” represents the upcoming bus is delayed and will be displayed when the waiting time is counted down to 0;
“last bus passed” represents no buses will arrive until next day;
“no bus services” represents the bus services are suspended temporarily due to typhoon or flooding; and
“out of service” represents current bus stops are out of service due to road closing, road construction, traffic accidents etc.

With these mode codes, the passengers waiting at the bus stops can know for certain how the bus services are.

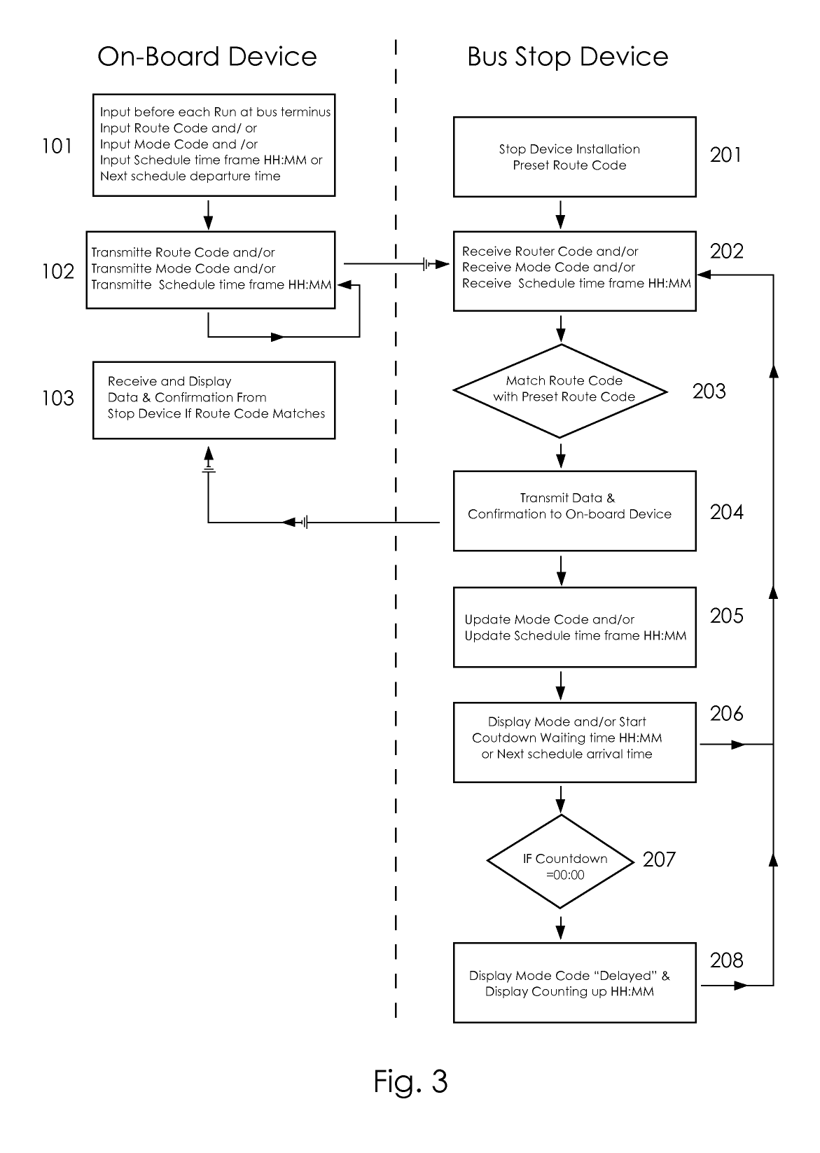

Referring now to FIG. 3, this figure shows a flow chart of the system for informing bus arrival information according to the invention. It should be noted that the invention utilizes short distance transceivers for both the on-board device and the bus stop devices so that the data therebetween is transmitted and received only when the bus arrives at or passes by the bus stop.

In step 101, the route code, mode code and the schedule time frame in hours and minutes or the next schedule departure time of the same route bus are input into the on-board device each time before the bus is going to departure from the terminus. The on-board device then carries the route code, mode code and the schedule time frame or the next schedule departure time. While in step 201, a bus stop device is installed with a preset route code at each of the bus stops for each particular bus route. When the bus is running along the bus line, the transceiver of the on-board device on the bus can continuously transmit the route code, mode code and the schedule time frame (Step 102). When the bus passes by the bus stop, the bus stop device which is provided with the short distance transceiver and installed at this bus stop is able to receive the data transmitted from the transceiver of the on-board device, if the preset route code matches with the route code of the on-board device, i.e. the mode code and/or the schedule time frame will be updated in the bus stop device (steps 202 to 205). The bus stop device may be actuated to send confirmation of receipt of the data to the on-board device (steps 103 and 204). Data transmission takes place between the bus stop device and the on-board device only when the bus route code matches with one another, whereby the bus stop devices with other route codes at the same bus step cannot be affected or interrupted. Once the schedule time frame is received and updated in the bus stop device, this bus stop device starts to count down, and the waiting time would be displayed on the display module of this bus stop device (step 206) until the next bus arrives at this bus stop, then step 206 goes back to step 202. The countdown starts again. If waiting time is counted down to 0 and the next bus is not coming, the bus stop device would switch to count up and cause its display module to display the mode code “delayed” and the count-up time until the arrival of this next bus (steps 207 and 208). When the delayed bus arrives at the bus stop, step 208 would go back to step 202, and the countdown starts again.

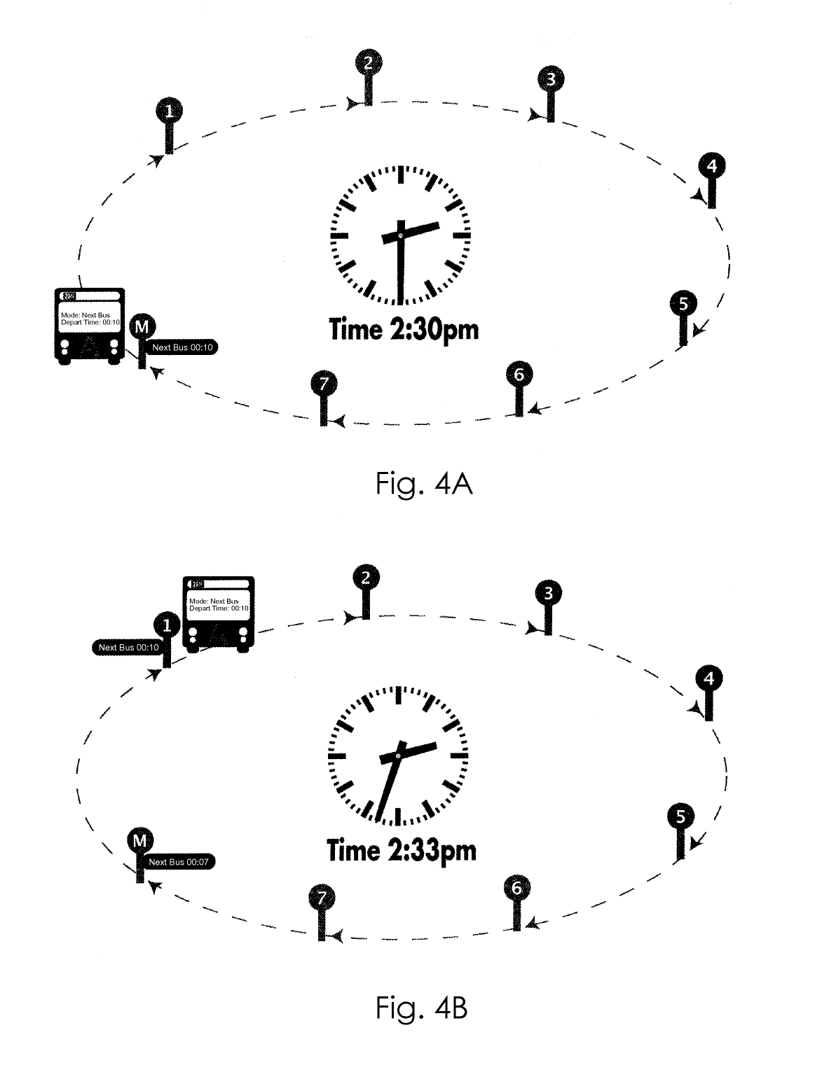

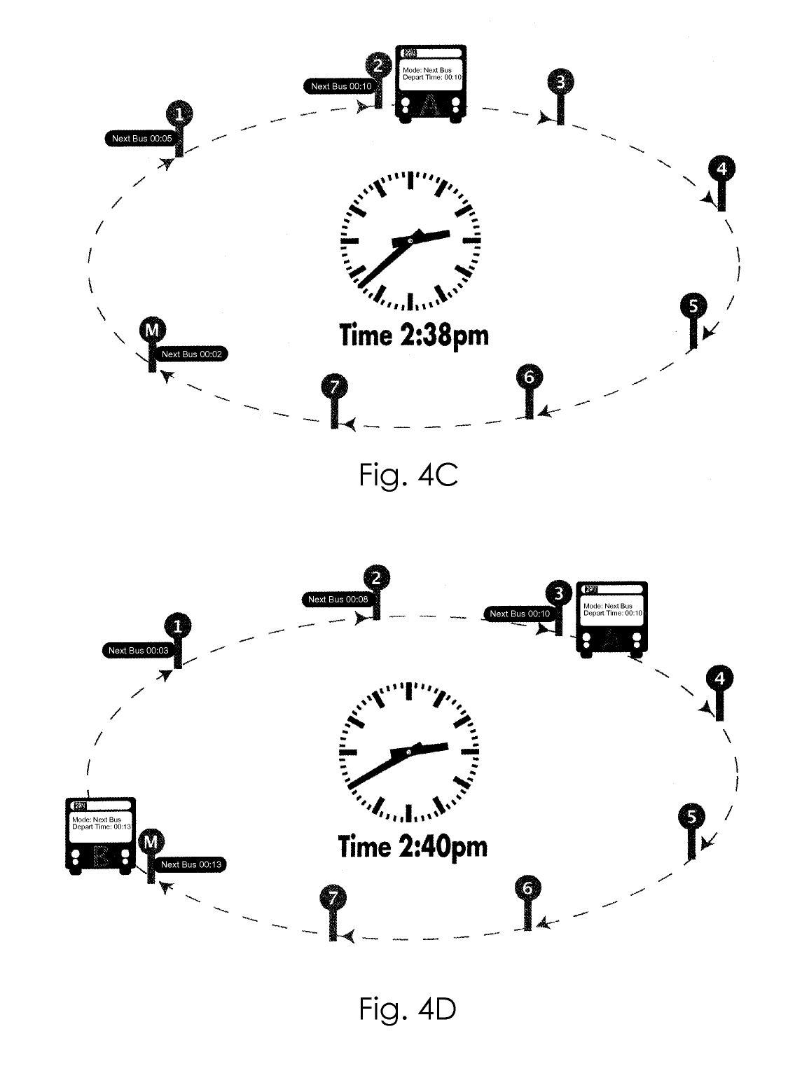

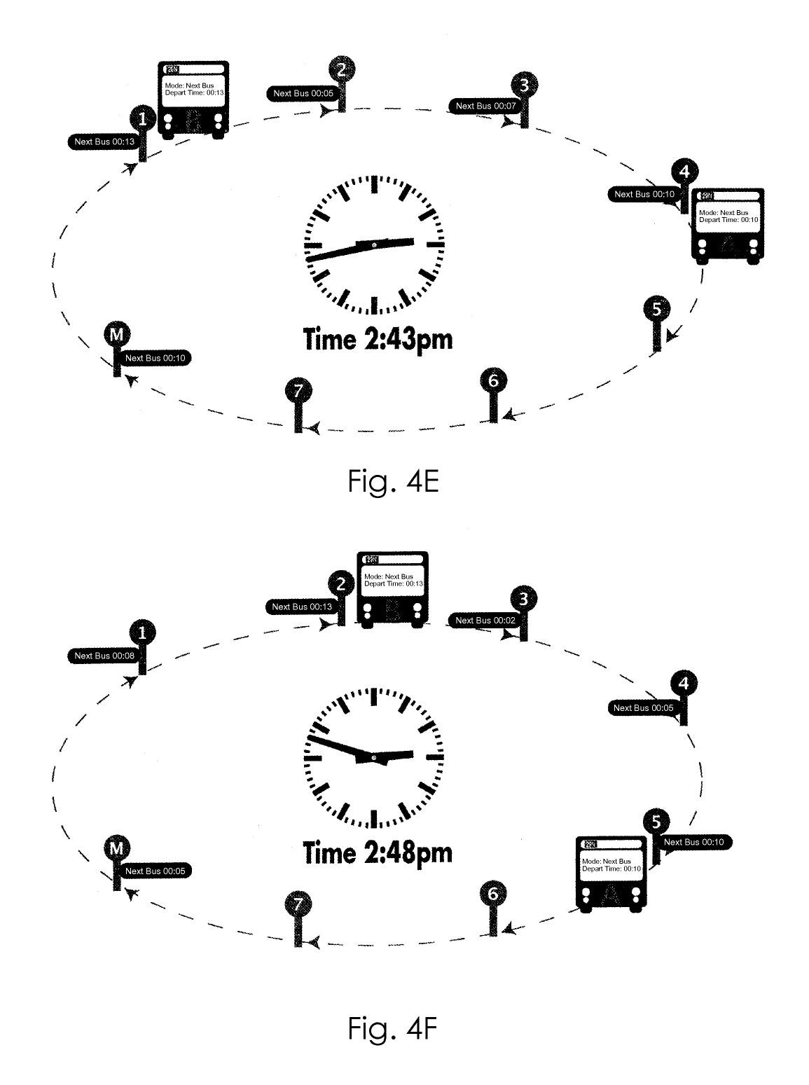

FIGS. 4A to 4F show how the system informs the passengers of the expected waiting time. At 2:30 pm Bus “A” is going to leave the terminus, and the on-board device of this bus is updated with the schedule time frame of 10 minutes. This bus “A” arrives at Bus Stop 1 at 2:33 pm, and the data transmission between the transceivers of the on-board device and the bus stop devices take place, whereby the corresponding bus stop device is updated with the mode code and the schedule time frame of 10minutes, and then starts to count down from 10 minutes. The countdown time is displayed on the display module of the bus-stop device. At this moment, the terminus stop device display “next bus 7 minutes”. This process goes on at 2:38 pm, 2:43 pm, and 2:48 pm . . . .

If there is typhoon or the like, all upcoming buses will be canceled. The last bus departing the terminus may be updated with the mode code of “no bus service”. When this last bus arrives at bus stop 1 where the bus stop device would be updated with the same mode code, allowing the passengers who come to bus stop 1 after the last bus has gone, to be informed that there will not be any bus services.

As described above, the invention utilizes the short distance transceivers for transmitting data between the bus and the bus stop, and utilizes the schedule time frame as the basis for counting down the waiting time of the upcoming bus. Therefore, the system of the invention eliminates the use of computer and network arrangements and the need of presenting bus schedule panel and of predefining schedule. Installation of the system of the invention is very easy and simple.

The invention thus provides a system for informing public transport vehicle arrival information which is a flexible and simple design and cost-effective. The system of the invention allows to add, cancel or adjust the bus modes and schedule time at any time due to particular events such as weather conditions, traffic accidents and/or road construction.

While the embodiments described herein are intended as an exemplary wall lamp fixture, it will be appreciated by those skilled in the art that the present invention is not limited to the embodiments illustrated. Those skilled in the art will envision many other possible variations and modifications by device of the skilled person's common knowledge without departing from the scope of the invention, however, such variations and modifications should fall into the scope of this invention.

What is claimed is:

1. A system for informing public transport vehicle arrival information, comprising:
a plurality of on-board devices installed on respective public transport vehicles, each of the on-board device having a transceiver for transmitting and receiving data from and to public transport vehicle stops along a public transport vehicle line, a first processing unit programmed to store and process the received data, and a first display module which is operatively coupled to the first processing unit and is for displaying the data, wherein the data includes identification of the vehicle, schedule time frame and next schedule departure time of a following vehicle, the schedule time frame being obtained by subtracting a current departure time at a vehicle terminus from a next schedule departure time; and
a plurality of public transport vehicle stop devices installed in the respective vehicle stops, each of the public transport vehicle stop device having a preset vehicle identification therein and having a transceiver for transmitting and receiving the data from and to the on-board device if the preset vehicle identification matches the vehicle identification of the on-board device, a second processing unit programmed to store and update the received data to count down a waiting time of the vehicle till zero and then, if necessary, switch to count up a delay time, and a second display module which is operatively coupled to the second processing unit and is for displaying the waiting time or the delay time and other information.

2. The system as claimed in claim 1, wherein the transceivers installed on the public transport vehicles and the public transport vehicle stops are selected from the group consisting of infrared transceiver, radio frequency transceiver and Bluetooth transceiver.

3. The system as claimed in claim 1, wherein the first processing unit and the second processing unit are integrated circuit (IC).

4. The system as claimed in claim 1, wherein the first processing unit and the second processing unit are microprocessors.

5. The system as claimed in claim 1, wherein the vehicle identification is a route code.

6. The system as claimed in claim 1, wherein the arrival information includes mode codes of the vehicle.

7. The system as claimed in claim 1, wherein a further transceiver is installed on the other side of the vehicle as a relaying transceiver.

8. The system as claimed in claim 1, wherein the second processing unit is programmed to transmit confirmation of receipt of the data to the on-board device.

9. The system as claimed in claim 1, wherein the second display is a digital display.

10. The system as claimed in claim 1, wherein the display is a LCD display.

11. The system as claimed in claim 1, wherein the arrival information is displayed in the format of the schedule time frame.

12. The system as claimed in claim 1, wherein the arrival information is displayed in the format of next schedule arrival time obtained by adding the schedule time frame to the current clock time of each of the vehicle stops.

13. The system as claimed in claim 1, wherein promotional messages, product information, news and weather briefs or the like are stored in the second processing unit so that they are made available intermittently to the public at the vehicle stops.

14. A method for informing public transport vehicle arrival information, comprising the steps of:
a) providing a plurality of on-board devices installed on respective public transport vehicles;
b) providing a plurality of public transport vehicle stop devices with preset identification of the vehicle, which are installed in the respective vehicle stops along a public transport vehicle line;
c) inputting identification of the vehicle, mode code and schedule time frame or next schedule departure time of a following vehicle into the on-board devices, the schedule time frame being obtained by subtracting a current departure time at a vehicle terminus from a next schedule departure time;
d) transmitting the vehicle identification, mode code and the schedule time frame to the plurality of public transport vehicle stop devices wherein the mode code and/or the schedule time frame is received and updated if the preset identification of the vehicle matches the vehicle identification of the on-board device;
e) on the basis of the updated schedule time frame, counting down a waiting time of the vehicle till zero and then, if necessary, switching to count up a delay time; and
f) displaying the waiting time or the delay time.

15. The method as claimed in claim 14, further comprising the step of transmitting confirmation of receipt of the vehicle identification, mode code and/or the schedule time frame from the public transport vehicle stop device to the on-board device.

16. The method as claimed in claim 14, wherein the step c) comprising displaying the vehicle identification and the schedule time frame or next schedule departure time of a following vehicle.

17. The method as claimed in claim 14, wherein the waiting time is displayed in the format of the schedule time frame in step f).

18. The method as claimed in claim 14, wherein the waiting time is displayed in the format of next schedule arrival time in step f), the next schedule arrival time being obtained by adding the schedule time frame to the current clock time of each of the vehicle stops.

19. The method as claimed in claim 14, wherein the step f) further comprising displaying promotional messages, product information, news and weather briefs or the like.
